(19) United States
(12) Patent Application Publication
(10) Pub. No.: US 2014/0212704 A1
(43) Pub. Date: Jul. 31, 2014

(54) MANIFOLD FOR FUEL CELLS

(71) Applicant: SCHNEIDER ELECTRIC IT CORPORATION, West Kingston, RI (US)

(72) Inventors: Kristian Silberbauer, Ribe (DK); Klaus Moth, Kolding (DK)

(73) Assignee: SCHNEIDER ELECTRIC IT CORPORATION, West Kingston, RI (US)

(21) Appl. No.: 14/089,092

(22) Filed: Nov. 25, 2013

Related U.S. Application Data
(63) Continuation of application No. 11/752,416, filed on May 23, 2007, now abandoned.

(51) Int. Cl. H01M 8/04; H01M 16/00

(52) U.S. Cl. CPC H01M 8/04201; H01M 8/04126; H01M 16/006
USPC 429/9; 429/458; 429/413; 429/429; 429/535

(57) ABSTRACT

A manifold for use with fuel cell and fuel cell stacks is provided. In certain examples, the manifold may be constructed and arranged to provide air to all cathodes in a first fuel cell stack fluidically coupled to the manifold and configured to provide fuel to all anodes in the first fuel cell stack. In some examples, the manifold may be constructed and arranged to provide air to all cathodes in a first fuel cell stack and a second fuel cell stack and to provide fuel to all anodes in the first fuel cell stack and the second fuel cell stack.

### FIELD OF THE TECHNOLOGY

Embodiments of the technology disclosed herein relate generally to a manifold for use with fuel cells. More particularly, certain examples disclosed herein relate to a manifold that may provide air to all cathodes of a fuel cell stack and fuel to all anodes of the fuel cell stack.

### BACKGROUND

A typical fuel cell assembly takes up a large amount of space due to the many components required. Most fuel cell assemblies include two end plates per stack. Each of the end plates includes a substantial number of fittings and interconnections for air, fuel, and exhaust, which requires additional space for the hoses.

### SUMMARY

In accordance with a first aspect, a manifold for use with a fuel cell stack is disclosed. In certain examples, the manifold may be constructed and arranged to provide air to all cathodes in a first fuel cell stack fluidically coupled to the manifold and configured to provide fuel to all anodes in the first fuel cell stack. In some examples, the manifold may further comprise an air inlet for receiving the air and a fuel inlet for receiving the fuel. In additional examples, the manifold may further comprise at least one air outlet on a first surface of the manifold and at least one fuel outlet on an opposite surface of the manifold. In certain examples, the manifold may further comprise at least one flow path for providing the air from the air inlet to the cathodes of the first fuel cell stack and at least one flow path for providing the fuel from the fuel inlet to the anodes of the first fuel cell stack. In some examples, the manifold may further comprise a humidifier coupled to at least one of the air outlet or an air inlet. In certain examples, the manifold may be further constructed and arranged to provide air to all cathodes of at least one additional fuel cell stack fluidically coupled to the manifold and to provide fuel to all anodes of the at least one fuel cell stack. In some examples, the manifold may further comprise a motor constructed and arranged to power the humidifier. In certain examples, the manifold may further comprise at least one air return on a surface of the manifold and at least one fuel return on a surface of the manifold. In some examples, the manifold may also comprise a first current collector coupled to the manifold and electrically coupled to the first fuel cell stack.

In accordance with another aspect, a fuel cell assembly is provided. In certain examples, the fuel cell assembly comprises a fuel cell stack, and a manifold fluidically coupled to the fuel cell stack. In some examples, the manifold may be constructed and arranged to provide air to all cathodes in the fuel cell stack and fuel to all anodes in the fuel cell stack. In some examples, the fuel cell assembly may further comprise at least one additional fuel cell stack fluidically coupled to the manifold, in which the manifold is constructed and arranged to provide air to all cathodes of the at least one additional fuel cell stack and to provide fuel to all anodes of the at least one additional fuel cell stack. In certain examples, the fuel cell assembly may further comprise a humidifier fluidically coupled to the manifold. In some examples, the fuel cell assembly may further comprise a motor configured to power the humidifier. In certain examples, the fuel cell stack and the at least one additional fuel cell stack may be in series and the manifold may be integrated between them. In some examples, the fuel cell stack may be selected from the group consisting of an alkaline fuel cell stack, a direct borohydride fuel cell stack, a metal hydride fuel cell stack, a direct ethanol fuel cell stack, a formic acid fuel cell stack, a proton exchange membrane fuel cell stack, a phosphoric acid fuel cell stack, a molten carbonate fuel cell stack, a protonic ceramic fuel cell stack, a direct methanol fuel cell stack and a solid oxide fuel cell stack. In certain examples, the manifold of the fuel cell assembly may comprise an air inlet, a fuel inlet, at least one air outlet fluidically coupled to the air inlet and at least one fuel outlet fluidically coupled to the fuel inlet. In some examples, the fuel cell assembly may further comprise a current collector coupled to the manifold and electrically coupled to the fuel cell stack. In certain examples, the fuel cell assembly may comprise a first current collector coupled to the manifold and electrically coupled to the fuel cell stack and a second current collector coupled to manifold and electrically coupled to the at least one additional fuel cell stack.

In accordance with another aspect, a power distribution system for a load is provided. In certain examples, the power distribution system comprises a fuel cell assembly comprising a fuel cell stack and a manifold constructed and arranged to provide air to all cathodes in the fuel cell stack and to provide fuel to all anodes in the fuel cell stack. In some examples, the power distribution system may further comprise a controller electrically coupled to the fuel cell assembly and configured to selectively couple the fuel cell assembly to the load. In certain examples, the power distribution system may further comprise at least one battery electrically coupled to the controller. In some examples, the controller may be configured to switch the fuel cell assembly on when a power loss is detected by the controller.

In accordance with an additional aspect, a method of assembling a fuel cell assembly is disclosed. In certain examples, the method comprises disposing a manifold between a first fuel cell stack and a second fuel cell stack to provide air to all cathodes of the first and second fuel cell stacks and to provide fuel to all anodes of the first and second fuel cell stacks during operation of the fuel cell assembly. In some examples, the method may also comprise disposing a humidifier on the manifold. In other examples, the method may comprise fluidically coupling the manifold to at least one additional fuel cell stack.

In accordance with another aspect, a method of facilitating assembly of a fuel cell assembly is disclosed. In certain examples, the method comprises providing a manifold constructed and arranged to provide air and fuel to a first fuel cell fluidically coupled to the manifold. In some examples, the method may comprise providing a first fuel cell stack and a second fuel cell stack. In other examples, the first fuel cell stack and the second fuel cell stack may be the same type of fuel cell stack.

In accordance with an additional aspect, a fuel cell assembly comprising a first fuel cell stack and means for simultaneously providing air and fuel to at least one fuel cell in the first fuel cell stack is provided.

Additional features, aspects and examples are described in more detail below.

### BRIEF DESCRIPTION OF THE FIGURES

Certain embodiments are described below with reference to the accompanying figures in which:

FIG. 1 is a manifold coupled to a first fuel cell, in accordance with certain examples,

FIG. 2 is a schematic showing air and fuel flow from a manifold to anodes and cathodes of a first fuel cell stack, in accordance with certain examples;

FIG. 3 is a schematic showing air and fuel flow from a manifold to all anodes and all cathodes of a first fuel cell stack and a second fuel cell stack, in accordance with certain examples;

FIG. 4 is a cross-section showing an internal flow path, in accordance with certain examples;

FIG. 5 is a cross-section showing two internal flow paths, in accordance with certain examples;

FIGS. 6A and 6B are perspective views of a manifold, in accordance with certain examples;

FIG. 7 is a cross-section of a manifold showing internal flow paths, in accordance with certain examples;

FIG. 8 is a perspective view of a fuel cell assembly with the fuel cell stacks arranged in series, in accordance with certain examples;

FIG. 9 is a perspective view of a fuel cell assembly with a humidifier and a motor attached to a manifold, in accordance with certain examples; and

FIG. 10 is a diagram of a power system including a standby power system comprising a fuel cell assembly, in accordance with certain examples.

Certain features shown in the figures may have been enlarged, distorted, altered or otherwise shown in a non-conventional manner to facilitate a better understanding of the technology disclosed herein.

### DETAILED DESCRIPTION

Certain embodiments of the devices and methods disclosed herein provide significant advantages to fuel cell assemblies including, but not limited to, design simplification, cost reduction, size reduction and/or improved performance.

In accordance with certain examples, the manifolds disclosed herein may be configured to provide air to a first fuel cell (or fuel cell stack) coupled to the manifold and fuel to the same fuel cell (or fuel cell stack) that is coupled to the manifold. In some examples, the manifold may be further configured to provide air and fuel to a second fuel cell stack coupled to the manifold. In certain examples, the manifold may be configured with a single air inlet and two or more air outlets. In other examples, the manifold may also be configured with a single fuel inlet and two or more fuel outlets. In certain examples, the manifold may include an air return to carry excess air (and any moisture therein) away from the fuel cells (or fuel cell stacks) and back to the manifold. In other examples, the manifold may include a fuel return to carry excess fuel back to the manifold. Additional features for including in a manifold are described in more detail below.

In accordance with certain examples, the manifolds disclosed herein may be configured to provide air and fuel to at least one fuel cell stack adjacent to a first surface of the manifold. This arrangement may be referred to in some instances herein as a centralized arrangement. The term “centralized” refers to the manifold being configured to provide both air and fuel to a fuel cell stack fluidically coupled to the manifold and not necessarily to the position of the manifold relative to two or more fuel cells. The manifold may be centrally positioned or may take other suitable positions as discussed in more detail below. The phrase “fluidically coupled” refers to two or more devices that are connected in a suitable manner such that a fluid, e.g., liquid, gas, supercritical fluid or the like, may flow between the devices. Devices may be fluidically coupled, for example, by placing a desired surface of one device in contact with a fluid port, e.g., an inlet or outlet, of the other device. Alternatively, devices may be fluidically coupled, for example, by placing a fluid flow path in contact with a fluid port. Though certain examples are described below with reference to a fuel cell, it will be recognized by the person of ordinary skill in the art, given the benefit of this disclosure, that the manifolds may also be coupled to a fuel cell which is part of a larger, fuel cell stack.

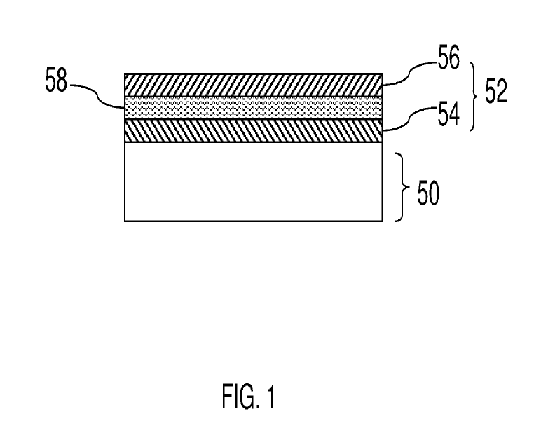

In accordance with certain examples and referring to FIG. 1, the manifold 50 may be fluidically coupled to a first fuel cell 52 to provide air and fuel to the first fuel cell 52. The first fuel cell 52 includes a cathode 54, an anode 56 and an electrolyte 58 between the cathode 54 and the anode 56. More particularly, the manifold 50 may be fluidically coupled to the cathode 54 of the first fuel cell 52 and the anode 56 of the first fuel cell 52. The manifold 50 may be configured with one or more ports or outlets and one or more flow paths or fluid channels to provide fuel to the anode 56 of the first fuel cell 52 and to provide air to the cathode 54 of the first fuel cell 52.

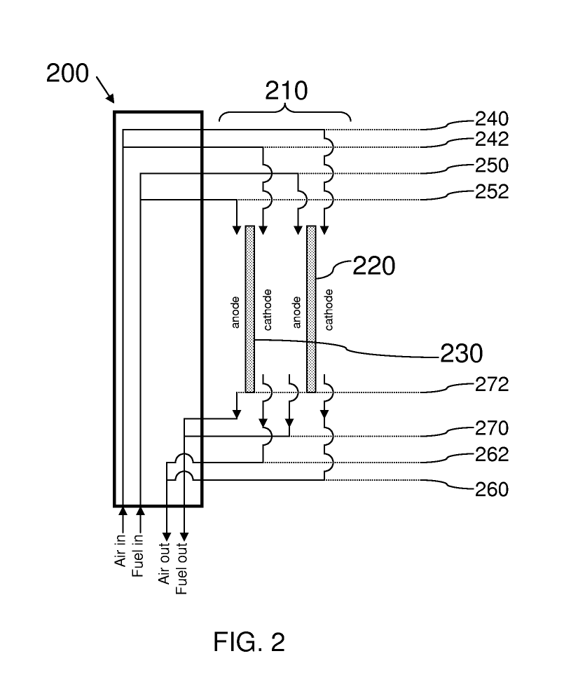

In certain examples, the manifold may be constructed and arrange to provide fuel to all anodes in a first fuel cell stack and to provide air to all cathodes in the same fuel cell stack. Referring to FIG. 2, a schematic of air and fuel flow from a manifold 200 to anodes and cathodes of a fuel cell stack 210 is shown. In the illustration in FIG. 2, only two of the fuel cells of the fuel cell stack are shown. It will be recognized by the person of ordinary skill in the art, given the benefit of this disclosure, that the fuel cell stack may include a plurality of fuel cells, e.g., 45-50 or more, and that the two fuel cells shown in FIG. 2 are for illustrative purposes only. In operation of the manifold 200, air may be provided to an air inlet and fuel may be provided to a fuel inlet. The manifold 200 may be constructed and arranged such that the air provided to the manifold may be provided to each cathode of the fuel cells 220 and 230 of the fuel cell stack 210 through flow paths 240 and 242, respectively. Similarly, the manifold 200 may also be constructed and arranged such that the fuel provided to the manifold may be provided to each anode of the fuel cells 220 and 230 through flow paths 250 and 252, respectively. The air provided to each of the cathodes of fuel cells 220 and 230 may be returned to the manifold 200 through flow paths 260 and 262, respectively, and exit the manifold 200 through an air outlet. Any excess fuel (and/or exhaust) provided to each of the anodes of the fuel cells 220 and 230 may be returned to the manifold 200 through flow paths 270 and 272, respectively, and exit the manifold 200 through a fuel outlet. In one configuration, the air and fuel may be distributed to each of the cathodes and anodes, respectively, through one or more channels in bipolar plates (not shown in FIG. 2) coupled to the fuel cells, such as the bipolar plates described in commonly assigned patent application bearing Attorney Docket No. A2000-706419 and entitled “BIPOLAR PLATE FOR USE IN FUEL CELL STACKS AND FUEL CELL ASSEMBLIES,” the entire disclosure of which is hereby incorporated herein by reference for all purposes.

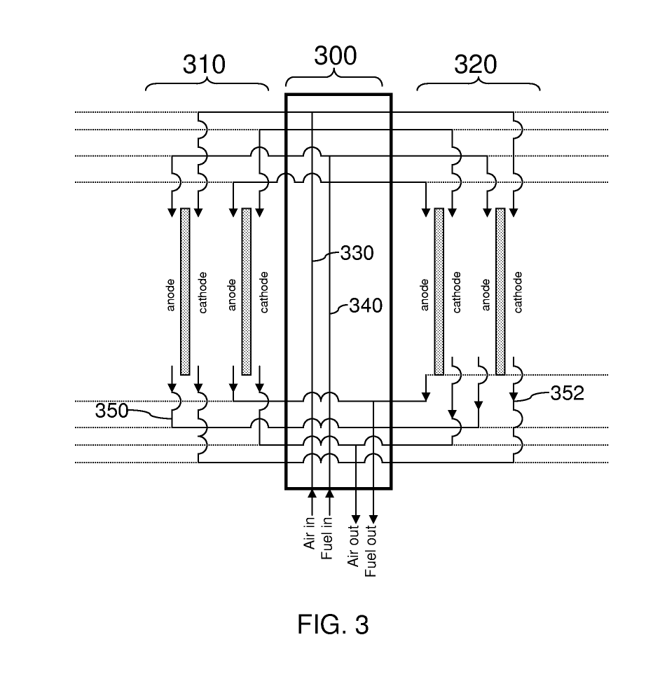

In certain examples, the manifold may be constructed and arranged to provide fuel to all anodes in a first fuel cell stack and all anodes in a second fuel cell stack and air to all cathodes in a first fuel cell stack and all cathodes in the second fuel cell stack. An illustration of this embodiment is shown in FIG. 3. The manifold 300 comprises a plurality of flows paths constructed and arranged to provide fuel to all anodes of a first fuel cell stack 310 and a second fuel cell stack 320, and air to all cathodes of the first fuel cell stack 310 and the second fuel cell stack 320. For example, a flow path 340 may be configured to provide fuel to all anodes of the first fuel cell stack 310 and the second fuel cell stack 320 by splitting the fuel flow into a plurality of channels or flow paths fluidically coupled to each of the anodes. Similarly, a flow path 330 may be configured to provide air to all cathodes of the first fuel cell stack 310 and the second fuel cell stack 320 by splitting the air flow into a plurality of channels or flow paths fluidically coupled to each of the cathodes. A plurality of return air and flow channels, such as air return flow path 352 and fuel return flow path 350, may be fluidically coupled to an air outlet and fuel outlet, respectively, to return air and fuel from the fuel cell stacks 310 and 320 to the manifold 300. As discussed above, the air and fuel may be distributed to each of the cathodes and anodes, respectively, through one or more channels in bipolar plates that are in fluid communication with the manifold 300.

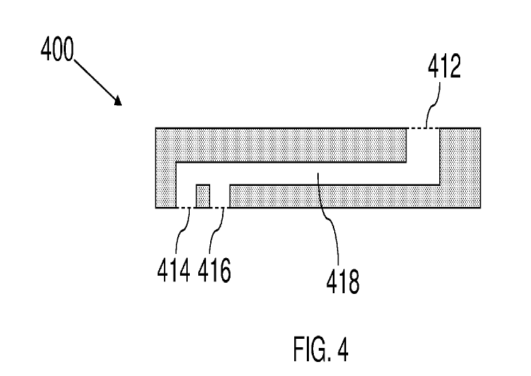

In accordance with certain examples, the manifolds disclosed herein may be configured with one or more internal channels or flow paths such that a fuel or air may flow from an inlet to two or more outlets. A cross-section of an illustrative manifold is shown in FIG. 4. The manifold 400 include an inlet 412 fluidically coupled to a first outlet 414 and a second outlet 416 through a flow path 418. The inlet may be configured to receive fuel from a fuel source (or a fuel pump fluidically coupled to the fuel source) or may be configured to receive air from an air source (or a pump fluidically coupled to the air source).

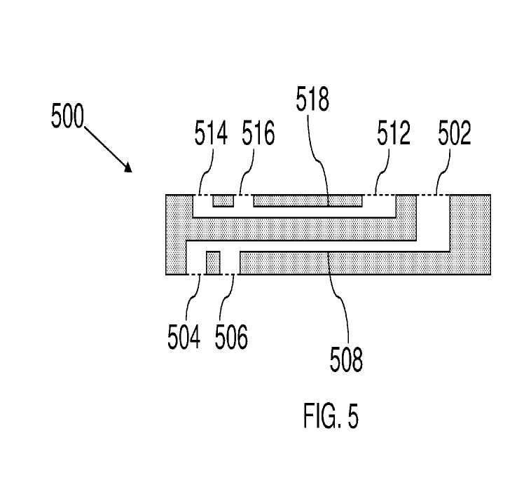

In certain examples, the manifold may be configured with an additional inlet as shown in FIG. 5. The manifold 500 may include a first inlet 502 and a second inlet 512. The first inlet 502 may be fluidically coupled with first and second outlets 504 and 506 through a flow path or channel 508. The second inlet 512 may be fluidically coupled with third and fourth outlets 514 and 516 through a second flow path or channel 518. Though the outlets 504 and 506 on one side of the manifold 500 are shown in FIG. 5 as being offset relative to the outlets 514 and 516 on an opposite side of the manifold 500, the outlets on each side of the manifold may be positioned anywhere along the manifold surface. In certain examples, the first and second outlets 504 and 506 may be positioned such that they provide fuel to the anode of a fuel cell (or the anodes of a fuel cell stack) fluidically coupled to the first and second outlets 504 and 506 and the third and fourth outlets 514 and 516 may be positioned such that they provide air to the cathode of a fuel cell (or the cathodes of a fuel cell stack) fluidically coupled to the third and fourth outlets 514 and 516. The fuel may be distributed to the anodes and air may be distributed to the cathodes through channels in one or more bipolar plates coupled to the fuel cell stack

In accordance with certain examples, the manifolds disclosed herein may include a current collector. The current collector may be configured to receive the electrons produced at the anode and to electrically couple the anode with the cathode. In a typical configuration, a current collector may be electrically coupled with each of the anode and the cathode and the two current collectors may be electrically coupled to each other. In one embodiment, the manifold may be constructed and arranged with a current collector positioned at one end of the manifold.

In accordance with certain examples, one or more backing layers may be placed between the electrodes and the current collectors. In certain examples, the backing layer may include one or more conductive materials, such as metals or graphite. In one embodiment, the backing layer may be a porous carbon paper or carbon cloth, e.g., about 2-15 mils thick. The porous nature of certain backing layers permits diffusion of the fuel and air from the manifold to the electrodes. The backing layer may also assist in diffusing the fuel or air out along the electrodes such that the fuel or air may be in contact with the entire surface area of the electrolyte.

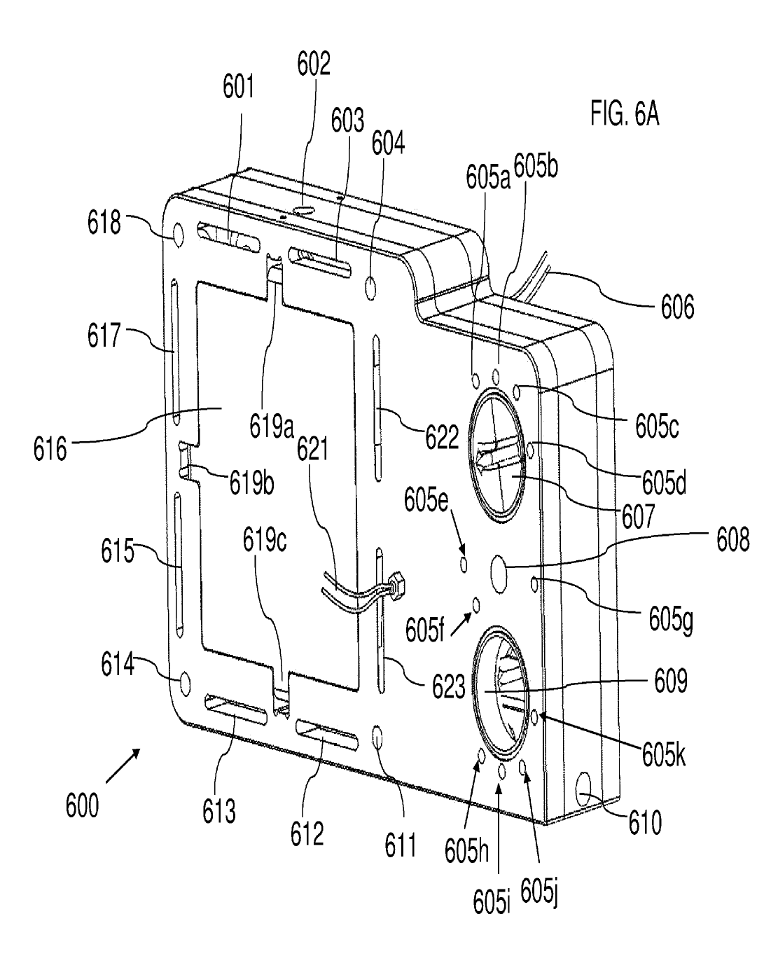

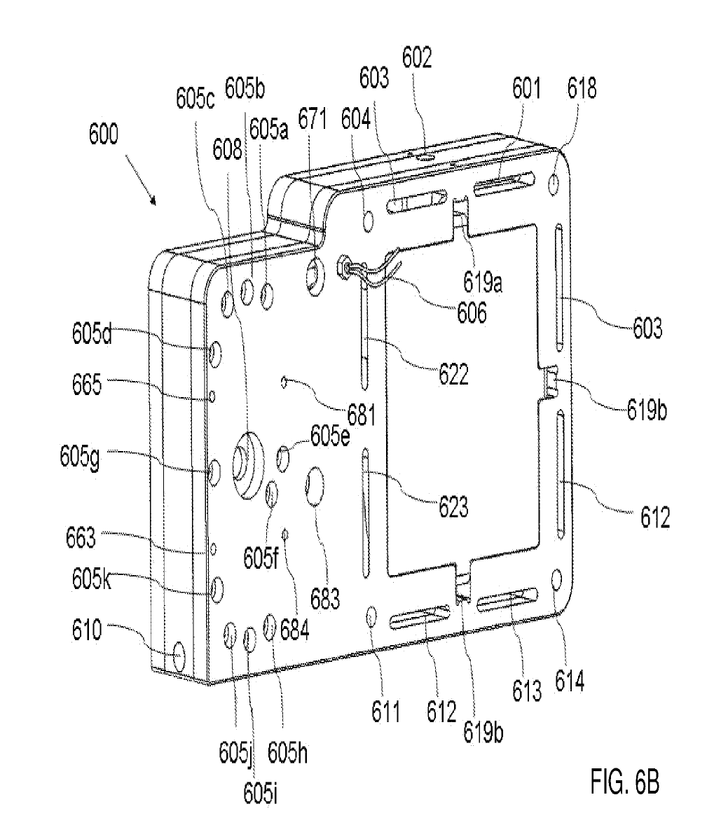

In accordance with certain examples, an illustrative manifold is shown in FIGS. 6A and 6B. The manifold 600 includes air inlets 601 and 622. Air inlets 601 and 622 may be configured to receive air from an external source or from ambient surroundings and to provide air to a fuel cell or fuel cell stack. Air inlets 601 and 622 may be fluidically coupled to an air port 607. The air port 607 may be fluidically coupled to a humidifier (not shown) to provide humidified air to the manifold 600. Fixtures 605a-605k may be used to attach the humidifier to the manifold 600. Manifold 600 may also include air returns 612 and 615 that are configured to receive air from a fuel cell (or fuel cell stack) and pass the air back to the manifold 600. The air returns 612 and 615 may each be fluidically coupled to a return port 609 that is configured to carry air and water away from the fuel cell and back to the humidifier. The manifold 600 may also include a drain port 610 configured to drain excess fluid from the manifold 600 to prevent improper functioning of the humidifier. The humidifier may be powered or driven by a shaft from a motor (not shown) coupled to the humidifier. The shaft may be inserted into aperture 608 of the manifold. In certain examples, a motor may be mounted to the manifold using fixtures 663, 665, 681 and 684 (see FIG. 6B). The motor may include a shaft which acts to drive or power the humidifier.

In certain examples, the manifold 600 also includes fuel outlets 613 and 623 that may be configured to deliver fuel to one or more fuel cells. The fuel outlets 613 and 623 may be fluidically coupled to a fuel inlet 683 that provides fuel to the manifold 600. Manifold 600 may also include fuel returns 603 and 617 that are configured to pass fuel from the fuel cell and back into the manifold 600.

In certain examples, manifold 600 may also includes various other features. For example, manifold 600 may include various apertures or threads for attaching selected devices to the manifold 600. For example, manifold 600 may include apertures 604, 611, 614 and 618 for receiving a fixation rod from a fuel cell (or fuel cell stack) to attach the manifold to the fuel cell (or fuel cell stack). The manifold 600 may also include a temperature sensor that is electrically coupled to a control system. For example, interconnect 606 may be electrically coupled to a control system to sense temperature of the fuel cell (or fuel cell stack). A temperature sensor may also be configured to measure fuel temperature prior to delivery of fuel to the fuel cells. For example, interconnect 621 may be electrically coupled to a control system to provide a fuel temperature to the control system. An additional temperature sensor may be used to measure the temperature of fuel returning to the manifold or for measuring the temperature of fuel and carbon dioxide exhaust exiting port 671.

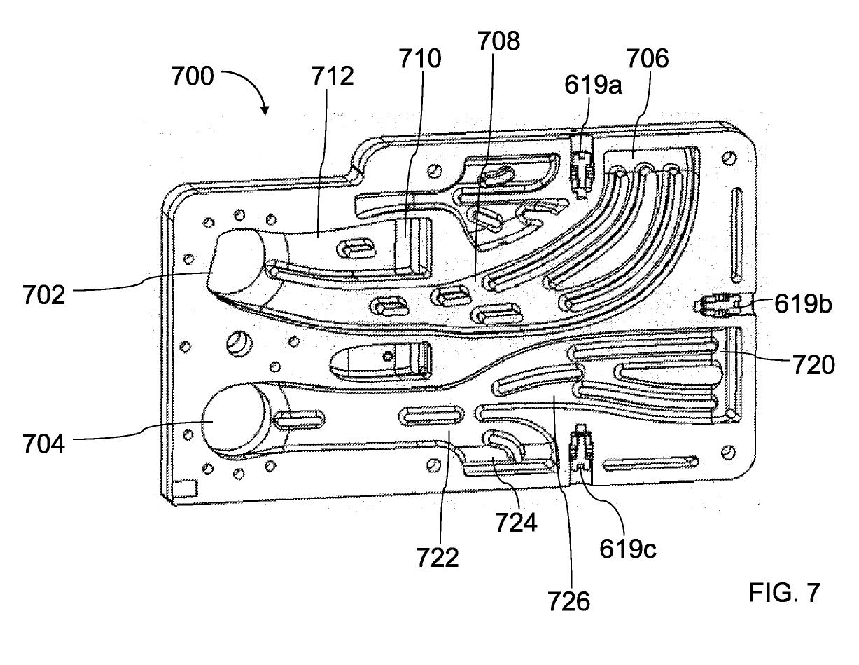

In accordance with certain examples, the manifolds disclosed herein may include a plurality of internal flow paths to provide air and fuel to the fuel cells (or fuel cell stacks) coupled to the manifolds. FIG. 7 shows an illustration of one configuration for internal air flow paths or channels. The manifold 700 includes an air inlet 702 to provide air into a fuel cell (or fuel cell stack), and an air outlet 704 to receive air and water from the fuel cell (or fuel cell stack) and provide it back to the manifold 700. The air inlet 702 may be fluidically coupled to an air inlet 706 through a flow path 708. The manifold 700 further includes an air inlet 710 which is fluidically coupled to the air inlet 702 through a flow path 712. The air inlets 706 and 710 provide air from the manifold and into the fuel cell (or fuel cell stack). Air and water may return from the fuel cell (or fuel cell stack) to air inlets 720 and 724. The air inlet 720 may be fluidically coupled to an air outlet 704 through a flow path 726, and the air inlet 724 may be fluidically coupled to the air outlet 704 through a flow path 722. The air inlets 720 and 724 may be configured to provide air and water back to the manifold from the fuel cell (or fuel cell stack). The fuel inlets and outlets may also be fluidically coupled in a manner similar to that shown in FIG. 7.

In accordance with certain examples, the manifold 700 may include at least one current collector. For example, manifold 600 includes a current collector 616 attached to the manifold 600 through one or more current collector connectors 619a, 619b, and 619c (see FIGS. 6A, 6B and 7). The current collector 616 may be electrically coupled to a fuel cell (or fuel cell stack). In one embodiment, the current collector may be coupled with the three current collector connectors (619a, 619b and 619c). The manifold 600 may be positioned between two stacks of fuel cells that are connected in series such that the two current collectors (one on each side of the manifold) may transfer the large currents produced by the fuel cell stacks to a device to be powered. In certain examples, the current collector may be attached to the manifold using a screw or other fastener inserted into aperture 602.

In accordance with certain examples, fuel exhaust exiting the manifold may be passed to a reformer or through a membrane to remove any unused fuel from the exhaust air prior to exiting of exhaust air from the fuel cell. Removal of unused fuel from the exhaust air prevents fuel from escaping into the atmosphere and can return fuel to the fuel source (or to a fuel inlet) to provide more efficient operating fuel cell assemblies. Exemplary reformers include, but are not limited to, in-line devices configured to burn excess fuel in the exhaust. Exemplary membranes for removing unused fuel from exhaust air include, but are not limited to polymeric membranes, cellulose based membranes, membranes with bound or trapped metals to chelate excess fuel, hydrophobic membranes and the like. It will be within the ability of the person of ordinary skill in the art, given the benefit of this disclosure, to select suitable devices and methods to remove unused fuel from the exhaust air.

In accordance with certain examples, the manifolds may be produced using many different materials. The exact materials used in the manifold may depend, at least in part, on the fuel cell stacks to be used with the manifold. Where the fuel cell stacks are designed to operate at high temperatures, e.g., greater than 500° C., it may be desirable to produce the manifold using stainless steel, ceramics, metals, silicium and other conductive materials. Where the fuel cell stacks are designed to operate at room temperature, e.g., about 20-25° C., the manifolds may be produced using plastics, elastomers, glass fiber armed epoxies, and the like. Suitable internal flow paths may be molded, pressed, carved, machined or etched into the manifolds to provide a desired configuration. In certain examples, the manifold may be produced by assembling three halves or pieces together to form the internal flow paths.

In accordance with certain examples, the manifolds disclosed herein may be used with many different types of fuel cell stacks. Illustrative types of fuel cell stacks that may be used with the manifolds disclosed herein include but are not limited to, alkaline fuel cell stacks, direct borohydride fuel cell stacks, metal hydride fuel cell stacks, direct ethanol fuel cell stacks, formic acid fuel cell stacks, proton exchange membrane fuel cell stacks, phosphoric acid fuel cell stacks, molten carbonate fuel cell stacks, protonic ceramic fuel cell stacks, and solid oxide fuel cell stacks.

In certain examples, an alkaline fuel cell stacks includes two or more alkaline fuel cells each including an anode, a cathode, and a porous matrix saturated with an aqueous alkaline solution between the anode and the cathode. The alkaline fuel cell uses hydrogen as a fuel and produces water from reaction of oxygen and protons at the cathode. In certain examples, a direct borohydride fuel cell stack is similar to an alkaline fuel cell stack but uses sodium borohydride as a fuel. A metal hydride fuel cell stack is also similar to an alkaline fuel cell stack but chemically bonds and stores hydrogen within the fuel cell stack. The manifolds disclosed herein may be used to provide sodium borohydride and air or hydrogen and air to the fuel cells of an alkaline fuel cell stack, a direct borohydride fuel cell stack or a metal hydride fuel cell stack.

In accordance with certain examples, a proton exchange membrane fuel cell includes a proton exchange membrane between an anode and a cathode. Protons migrate from the anode to the cathode where they react with oxygen and electrons produced at the anode to form water. A direct ethanol fuel cell stack uses a proton exchange membrane between the cathode and the anode, uses ethanol as a fuel and converts the ethanol into carbon dioxide and water. A formic acid fuel cell stack uses a proton exchange membrane between the cathode and the anode, uses formic acid as the fuel and converts the formic acid into carbon dioxide and water. The manifolds disclosed herein may be used to provide ethanol, formic acid or other selected fuel and air to the fuel cells in a proton exchange membrane fuel cell stack.

In accordance with certain examples, a phosphoric acid fuel cell stack uses liquid phosphoric acid as an electrolyte, hydrogen as a fuel and converts the hydrogen into water. The manifolds disclosed herein may be used to provide hydrogen and air (oxygen) to the fuel cells in a phosphoric acid fuel cell stack.

In accordance with certain examples, a molten carbonate fuel cell stack uses a molten carbonate salt mixture suspended in a porous, chemically inert ceramic matrix of beta-alumina solid electrolyte (BASE). The molten carbonate fuel cell stack can reform a hydrocarbon based fuel into hydrogen and subsequently convert the hydrogen into water. The manifolds disclosed herein may be used to provide a hydrocarbon fuel and air to the fuel cells in a molten carbonate fuel cell stack.

In accordance with certain examples, a protonic ceramic fuel cell stack includes a ceramic electrolyte between the cathode and the anode. The ceramic electrolyte conducts protons at elevated temperatures, e.g., about 700° C. A hydrocarbon fuel may be supplied to the anode and directly converted into protons and carbon dioxide without having to convert the hydrocarbon fuel into hydrogen. The manifolds disclosed herein may be used to provide a hydrocarbon fuel and air to the fuel cells in a protonic ceramic fuel cell stack.

In accordance with certain examples, a solid oxide fuel cell stack includes a ceramic electrolyte, e.g., ZrO₂, between the anode and the cathode. Hydrogen fuel is supplied to the anode where it reacts with oxygen ions transferred through the solid oxide electrolyte. The manifolds disclosed herein may be used to provide hydrogen and air to the fuel cells in a solid oxide fuel cell stack.

In embodiments where one or more of the fuel cell stacks are configured as a direct methanol fuel cell stack, methanol may be provided to the anode and oxygen may be provided to the cathode to produce water at the cathode and carbon dioxide at the anode. Six protons and six electrons are produced per mole of methanol consumed at the anode. The electrons are transported by a circuit from the anode to the cathode and may be used to provide power to external devices. The protons migrate from the anode through the electrolyte, which typically is a polymer electrolyte membrane, to the cathode where they react with the oxygen and the electrons to produce water. Similarly, where the fuel cell is a hydrogen fuel cell, hydrogen may be provided to the anode and oxygen may be provided to the cathode. For each molecule of hydrogen (H₂) gas consumed, 2 protons and 2 electrons are produced at the anode. The protons may migrate through a polymer electrolyte membrane to the cathode. The electrons produced at the anode may be transported by a circuit from the anode to the cathode and may be used to power external devices. Oxygen at the cathode reacts with the protons and the electrons to produce water.

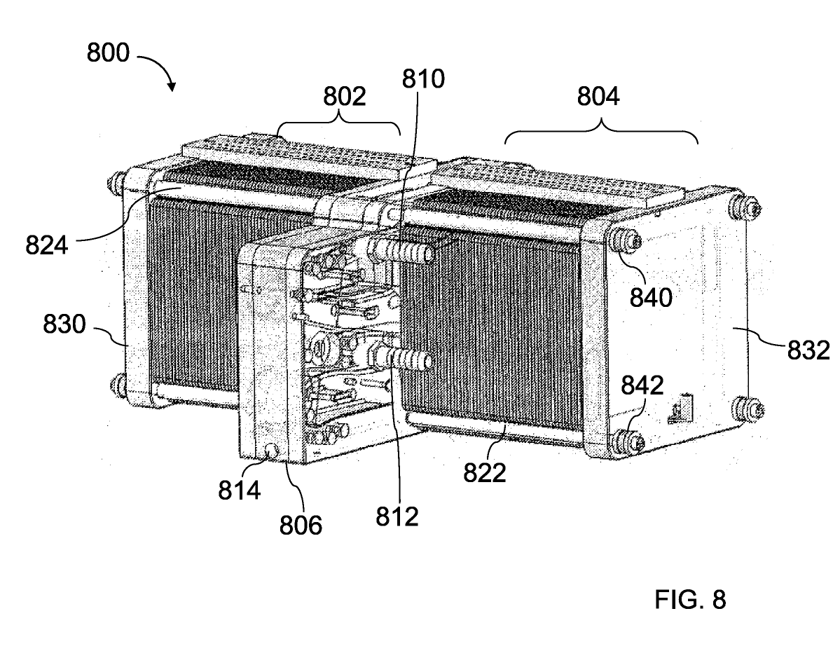

In accordance with certain examples, the fuel cell stacks coupled to the manifolds disclosed herein may be configured in many different arrangements. In certain examples, the fuel cell stacks may be arranged in series with a manifold between the two fuel cell stacks. An example of this arrangement is shown in FIG. 8. The fuel cell assembly 800 includes a first fuel cell stack 802, a second fuel cell stack 804 and a manifold 806 between the first fuel cell stack 802 and the second fuel cell stack 804. The manifold 806 is similar to the manifold described in reference to FIGS. 6A and 6B. For example the manifold 806 includes a fuel outlet 810, a fuel inlet 812 and a drain port 814. The fuel cell assembly 800 may be held in place using a plurality of fixation rods and two or more end plates. For example, fixations rods 822 and 824 may be inserted through the fixation apertures in the manifold 806 and through end plates 830 and 832. One or more fasteners, such as fasteners 840 and 842 may be used to hold the end plates 830 and 832 in position.

In other examples, the fuel cell stacks may be arranged in parallel, with a shared manifold at one end of the fuel cell stacks. In yet other examples, the fuel cell stacks may be arranged in a star-shaped configuration, with three or more fuel cell stacks sharing a common manifold. Additional suitable arrangements for fuel cell assemblies will be readily selected by the person of ordinary skill in the art, given the benefit of this disclosure.

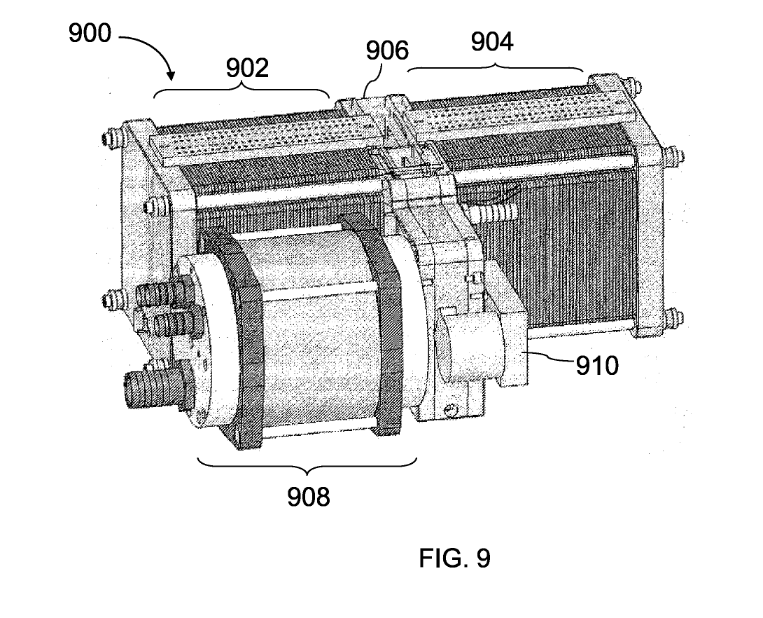

In accordance with certain examples, an illustrative fuel cell assembly is shown in FIG. 9. The fuel cell assembly 900 includes a first fuel cell stack 902, a second fuel cell stack 904 and a manifold 906 between the first fuel cell stack 902 and the second fuel cell stack 906. The manifold 906 is fluidically coupled to a humidifier 908. The humidifier 908 is driven or powered by a motor 910 which is mounted to the manifold 906. As discussed herein, the humidifier 908 may assist in providing humidified air and/or humidified fuel, e.g., humidified methanol, to the fuel cell stacks 902 and 904 coupled to the manifold 906. Though the fuel cell assembly is shown in FIG. 9 as having fuel cell stacks arranged in series, the fuel cell assembly may include fuel cell stacks arranged in parallel, arranged in a star-shaped configuration or arranged in other suitable configurations.

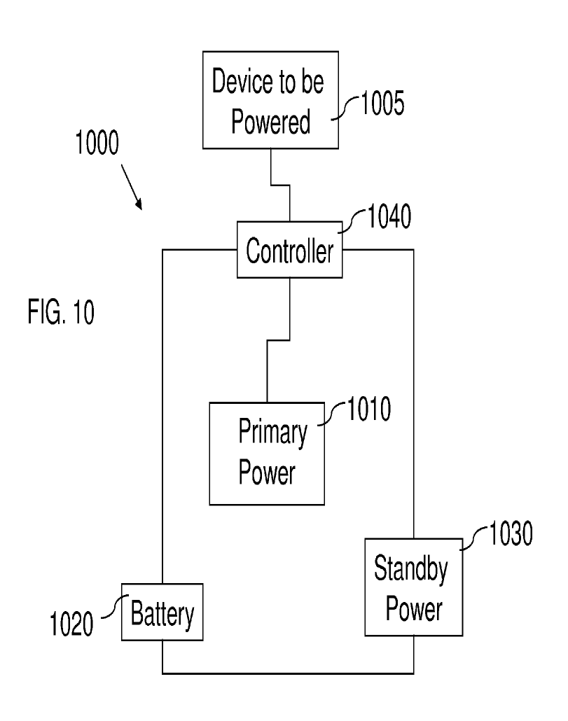

In accordance with certain examples, a power distribution system for a load is provided. In certain examples, the power distribution system includes a primary power source and a standby power source. In some examples, the standby power source may include a fuel cell assembly. In certain examples, the fuel cell assembly may include a first fuel cell stack, a second fuel cell stack, and a manifold constructed and arranged to provide air and fuel to at least one fuel cell in the first fuel cell stack and/or to provide air and fuel to at least one fuel cell in the second fuel cell stack. In some examples, the standby power source may be electrically coupled to a controller that may be configured to detect a power loss. Illustrative controllers are described, for example, in commonly assigned U.S. Pat. No. 7,142,950, the entire disclosure of which is hereby incorporated herein by reference. Referring to FIG. 10, an example of a power distribution system is shown. The power distribution system 1000 includes a primary power source 1010 for powering a device 1005, a battery 1020, and a standby power source 1030 each electrically coupled to a controller 1040. In certain examples, the standby power source 1030 may be implemented using one or more of the fuel cell stacks or fuel cell assemblies as described herein. In normal operation, the power system 1000 provides power to the device to be powered 1005 using the primary power source 1010, which typically is an alternating current source. When the primary power source 1010 is functioning properly, the standby power source 1030 may be switched off or may be used to charge (or recharge) the battery 1020. When the primary power source 1010 fails, the controller 1040 may send a signal to provide standby power from the standby power source 1030 to the device to be powered 1005. In certain examples, standby power may be temporarily supplied by the battery 1030 until the fuel cell assembly of the standby power source 1030 is operating at a sufficient level to provide a desired level of power. In the case where the standby power source 1030 is already operating at a desired level, the battery 1020 may be omitted or not used to provide power to the device to be powered 1005. Alternatively, in the case where standby power is not needed immediately, the battery 1020 may be omitted and there may be a delay prior to providing power from the standby power source 1030 to the device to be powered 1005. Additional configurations and uses of a standby power source will be readily selected by the person of ordinary skill in the art, given the benefit of this disclosure.

In accordance with certain examples, the fuel cell stacks and fuel cell assemblies disclosed herein may be used in many additional devices including but not limited to, vehicles such as automobiles and recreational vehicles. The manifolds disclosed herein permit a smaller footprint for the fuel cell assemblies, which facilitate their use in applications having limited space such as in a motor vehicle. In certain configurations, the vehicle may be co-powered by an engine and a fuel cell assembly that comprises a first fuel cell stack, a second fuel cell stack and a manifold constructed and arranged to provide air and fuel to at least one fuel cell in the first fuel cell stack and/or to provide air and fuel to at least one fuel cell in the second fuel cell stack. In some examples, the fuel cell assemblies may be designed to power or co-power the vehicle. In other examples, the fuel cell assembly does not power the drive wheels of the vehicle but may provide power for accessory devices such as, for example, televisions, stoves, lights and the like. The fuel cell assembly may include a fuel reservoir, e.g., a hydrogen or methanol fuel reservoir, that may be refilled by a user at a selected interval. The fuel reservoir may be positioned external to the vehicle and take the form of a tank or other device that may be coupled to the fuel cell through one or more flow paths such as a hose. Alternatively, an empty fuel reservoir may be exchanged for a filled fuel reservoir to provide fuel to the fuel cell assembly. The vehicle may include an air pump or other device positioned externally, e.g., on the roof or at the front bumper, to provide air to the fuel cell assembly. Additional features for including in a fuel cell assembly designed to provide primary or secondary power to a vehicle will be readily selected by the person of ordinary skill in the art, given the benefit of this disclosure.

In accordance with certain examples, a method of assembling a fuel cell assembly is provided. In certain examples, the method may comprise disposing a manifold between a first fuel cell stack and a second fuel cell stack to provide air and fuel to the first fuel cell stack and to provide air and fuel to the second fuel cell stack during operation of the fuel cell assembly. In certain embodiments, the manifold may be disposed and fluidically coupled to the first and second fuel cell stacks such that air and fuel may be provided to the first fuel cell stack and air and fuel may be provided to the second fuel cell stack during operation of the fuel cell assembly. In some examples, the method may further comprise disposing a humidifier on the manifold. In other examples, the method may further comprise fluidically coupling the manifold to at least a third fuel cell stack. In some examples, the manifold may be fluidically coupled to four or more fuel cell stacks.

In accordance with certain examples, a method of facilitating assembly of a fuel cell assembly is disclosed. In certain examples, the method may comprise providing a manifold constructed and arranged to provide air and fuel to a first fuel cell coupled to the manifold and optionally to provide air and fuel to a second fuel cell coupled to the manifold. In certain examples, the method may further comprise providing a first fuel cell stack and a second fuel cell stack. In some examples, the first fuel cell stack and the second fuel cell stack may be the same type of fuel cell stack, e.g., direct methanol fuel cell stacks.

In accordance with certain examples, a fuel cell assembly comprising a first fuel cell stack and means for simultaneously providing air and fuel to at least one fuel cell in the first fuel cell stack is provided. In certain examples, the means for providing air may also provide air and fuel to at least one additional fuel cell stack coupled to the manifold. The means for providing air and fuel simultaneously to the fuel cell stack(s) may be any one or more of the illustrative manifolds described herein. The means for providing air and fuel does not necessarily provide air and fuel at the same time, or all the time, but instead may be configured to provide air and fuel to a first fuel cell stack, and optionally at least one additional fuel cell stack, at least some time during operation of the fuel cell assembly.

When introducing elements of the examples disclosed herein, the articles “a, “an,” “the ” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1-9. (canceled)

10. A fuel cell assembly comprising:
a fuel cell stack; and
a manifold fluidically coupled to the fuel cell stack, the manifold constructed and arranged to provide air to all cathodes in the fuel cell stack and fuel to all anodes in the fuel cell stack.

11. The fuel cell assembly of claim 10, further comprising at least one additional fuel cell stack fluidically coupled to the manifold, in which the manifold is constructed and arranged to provide air to all cathodes of the at least one additional fuel cell stack and to provide fuel to all anodes of the at least one additional fuel cell stack.

12. The fuel cell assembly of claim 10, further comprising a humidifier fluidically coupled to the manifold.

13. The fuel cell assembly of claim 10, further comprising a motor configured to power the humidifier.

14. The fuel cell assembly of claim 11, in which the fuel cell stack and the at least one additional fuel cell stack are in series and the manifold is integrated between them.

15. The fuel cell assembly of claim 10, in which the fuel cell stack is selected from the group consisting of an alkaline fuel cell stack, a direct borohydride fuel cell stack, a metal hydride fuel cell stack, a direct ethanol fuel cell stack, a formic acid fuel cell stack, a proton exchange membrane fuel cell stack, a phosphoric acid fuel cell stack, a molten carbonate fuel cell stack, a protonic ceramic fuel cell stack, a direct methanol fuel cell stack and a solid oxide fuel cell stack.

16. The fuel cell assembly of claim 10, in which the manifold comprises an air inlet, a fuel inlet, at least one air outlet fluidically coupled to the air inlet and at least one fuel outlet fluidically coupled to the fuel inlet.

17. The fuel cell assembly of claim 10, further comprising a current collector coupled to the manifold and electrically coupled to the fuel cell stack.

18. The fuel cell assembly of claim 11, further comprising a first current collector coupled to the manifold and electrically coupled to the fuel cell stack and a second current collector coupled to manifold and electrically coupled to the at least one additional fuel cell stack.

19. A power distribution system for a load comprising:
a fuel cell assembly comprising
a fuel cell stack;
a manifold constructed and arranged to provide air to all cathodes in the fuel cell stack and to provide fuel to all anodes in the fuel cell stack; and
a controller electrically coupled to the fuel cell assembly and configured to selectively couple the fuel cell assembly to the load.

20. The power distribution system of claim 19, further comprising at least one battery electrically coupled to the controller.

21. The power distribution system of claim 19, in which the controller is configured to switch the fuel cell assembly on when a power loss is detected by the controller.

22. A method of assembling a fuel cell assembly comprising disposing a manifold between a first fuel cell stack and a second fuel cell stack to provide air to all cathodes of the first and second fuel cell stacks and to provide fuel to all anodes of the first and second fuel cell stacks during operation of the fuel cell assembly.

23. The method of claim 22, further comprising disposing a humidifier on the manifold.

24. The method of claim 22, further comprising fluidically coupling the manifold to at least one additional fuel cell stack.

25-28. (canceled)
